(19) United States
(12) Patent Application Publication
(10) Pub. No.: US 2006/0272583 A1
(43) Pub. Date: Dec. 7, 2006

(54) ONE-PIECE CONTOURED PET BED OF MOLDED MEMORY FOAM

(76) Inventor: Thomas W. BROWN, Shawnee, KS (US)

Correspondence Address: SPENCER, FANE, BRITT & BROWNE, 1000 WALNUT STREET, SUITE 1400, KANSAS CITY, MO, 64106-2140, US

(21) Appl. No.: 11/465,379

(22) Filed: Aug. 17, 2006

Related U.S. Application Data
(63) Continuation of application No. 10/887,942, filed on Jul. 9, 2004.

(51) Int. Cl. A01K 1/035

(52) U.S. Cl. 119/28.5

(57) ABSTRACT

A pet bed comprising a one-piece body including a base having a top surface, a wall structure, and a recessed space. The one-piece body is molded from a polyurethane visco-elastic foam material having a thermal response characteristic. The top surface is provided with a complex, three-dimensional surface contour having a concave contour component. The wall structure cooperates with the top surface to form and define a “nesting cradle”. The recessed space is provided to receive and retain any of a number of accessory, complementary, or otherwise desirable items. The solid, one-piece molded construction decreases production costs and increases product durability and longevity over prior art multi-piece pet beds, and the memory foam material and complex surface contouring work to avoid pressure points and provide even weight distribution, thereby minimizing loss of circulation and resulting numbness and resulting in more restful sleep.

### RELATED APPLICATIONS

The present non-provisional patent application is a continuation and claims priority benefit of an earlier-filed non-provisional patent application of the same title, Ser. No. 10/887,942, filed Jul. 9, 2004. The identified earlier-filed application is hereby incorporated by reference into the present application.

### BACKGROUND OF THE INVENTION

1. Field of the Invention

The present invention relates generally to beds and bedding for animals. More specifically, the present invention concerns a bed for a pet or other animal comprising a one-piece body of molded conforming (“memory”) foam having a contoured top surface to more comfortably and therapeutically accommodate the animal laying thereon, a surrounding wall structure for defining a nesting cradle, and a recessed space for receiving an accessory, complementary, or otherwise desirable item.

2. Description of the Related Art

It is often desirable to provide a bed for a pet or other animal, and, to that end, a variety of pet bed designs are known in the prior art. Unfortunately these prior art pet beds suffer from a number of problems and disadvantages. Many, for example, are of multi-piece designs that result in increased production costs and decreased durability and longevity. Furthermore, many of the prior art pet beds, both single- and multi-piece designs, give little consideration toward maximizing comfort, resulting in numerous pressure-points that may be particularly troublesome for older, injured, or sickly pets, and some are so poorly designed that they may themselves contribute to health problems with long-term use.

Due to these and other problems and disadvantages in the prior art, a need exists for an improved pet bed.

### SUMMARY OF THE INVENTION

The present invention overcomes the above-described and other problems and disadvantages in the prior art by providing an improved bed for pets or other animals. The pet bed broadly comprises a one-piece body including a base having a top surface, a wall structure, and a recessed space. The one-piece body is molded from a polyurethane visco-elastic foam material able to conform itself to a particular animal's body laying thereon. The base presents a substantially flat bottom surface and the aforementioned top surface. The top surface is provided with a complex, three-dimensional surface contour, having a concave contour component, to further accommodate the animal laying thereon. The wall structure rises substantially vertically upward from the base and extends around at least a portion of the complex surface contour of the top surface to form and define a “nesting cradle” within which the animal is likely to feel even more comfortable and secure. The recessed space is provided in the body to receive and retain any of a number of accessory, complementary, or otherwise desirable substances, devices, or other items, such as, for example, insect repelling or aromatic substances (e.g., cedar or eucalyptus), a heating or cooling mechanism, a soothing sound generating mechanism, a motion (e.g., vibration) generating mechanism, or a special therapeutic device or mechanism. The bed may also include a removable washable cover. Additionally, the bed may include a gel insert component associated with the top surface and operable to conduct heat away from the top surface and an animal laying thereon.

Thus, it will be appreciated that the pet bed of the present invention provides a number of advantages over the prior art, including, for example, decreased production costs, increased durability and longevity, therapeutic benefits, and improved comfort and support. More specifically, solid, one-piece molded construction decreases production costs and increases product durability and longevity over prior art multi-piece pet beds. The present invention maximizes comfort through use of both the memory foam material and the complex surface contouring of the top surface which works to reduce pressure per unit area, avoid pressure points, and provide even weight distribution. Such even weight distribution provides the additional benefit of avoiding loss of circulation and resulting numbness.

These and other details and features of the present invention are more fully described in the section titled DETAILED DESCRIPTION OF A PREFERRED EMBODIMENT, below.

### BRIEF DESCRIPTION OF THE DRAWINGS

A preferred embodiment of the present invention is described in detail below with reference to the attached drawing figures, wherein:

FIG. 1 is an isometric view of a preferred embodiment of the pet bed of the present invention;

FIG. 2 is a front elevation view of the pet bed of FIG. 1;

FIG. 3 is a side elevation section view of the pet bed of FIG. 1;

FIG. 4 is a plan view of the pet bed of FIG. 1;

FIG. 5 is an isometric view of the pet bed of the present invention wherein a wall component thereof is shown extending less than completely around a top surface component thereof; and

FIG. 6 is an isometric view of the pet bed of the present invention shown with a gel insert component.

### DETAILED DESCRIPTION OF A PREFERRED EMBODIMENT

With reference to the figures, a pet bed 10 is herein described, shown, and otherwise disclosed in accordance with a preferred embodiment of the present invention. The pet bed 10 is adapted and operable for use as a bed for pets or other animals, being advantageously designed to both decrease production costs, increase durability and longevity, provide therapeutic benefits, and improve comfort and support.

In the preferred embodiment, the bed 10 broadly comprises a one-piece body 12 including a base 14 having a top surface 16; a wall structure 18, and one or more recessed spaces 20a,20b. The one-piece body 12 is molded (using, e.g., aluminum molds) or otherwise constructed from a polyurethane visco-elastic foam material (“memory foam”) having a thermal response characteristic for conforming itself to a particular animal's body laying thereon. It will be appreciated that solid, one-piece molded construction decreases production costs and increases product durability and longevity. It will also be appreciated that use of the memory foam material allows for minimizing or eliminating pressure-points to facilitate more restful sleep, and provides therapeutic benefits such as, for example, supplementing post-operative care and treatments for such animal ailments as hip dysphasia.

The base 14 presents a bottom surface and the aforementioned top surface 16. The bottom surface is substantially flat so as to lay evenly upon a floor or other surface. The top surface 16 is provided with a complex, three-dimensional surface contour 22, having a concave contour component, to further accommodate the animal laying thereon.

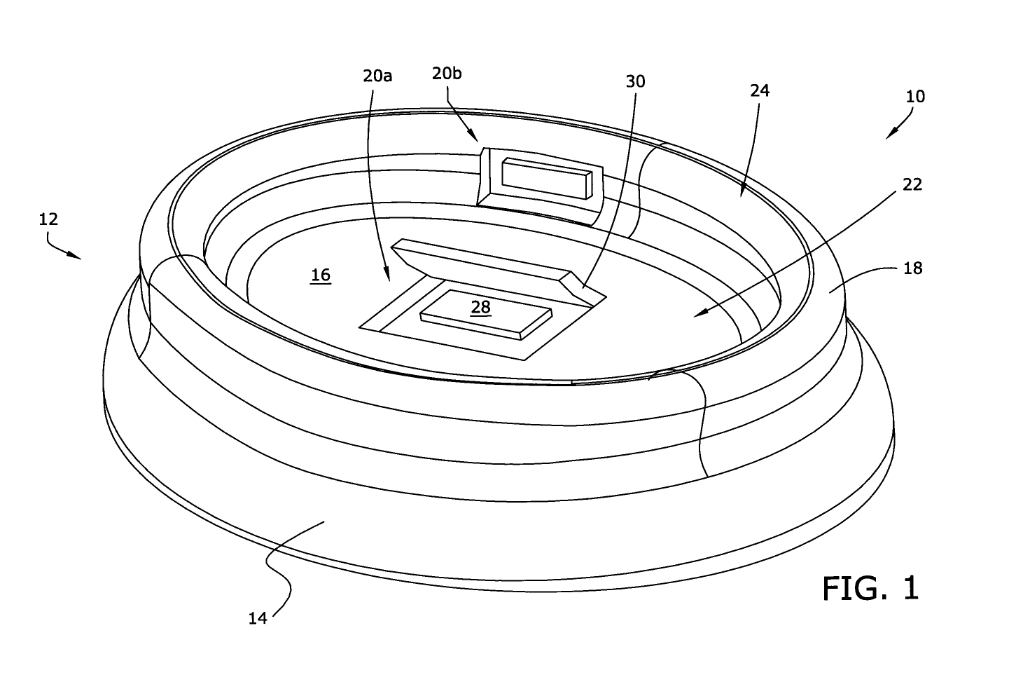

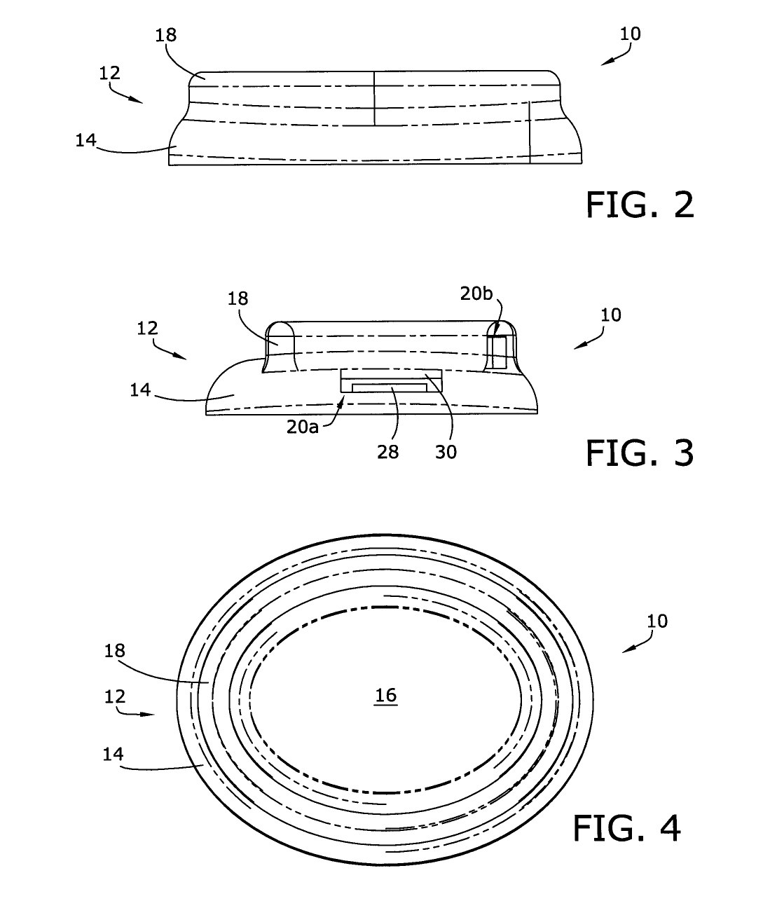

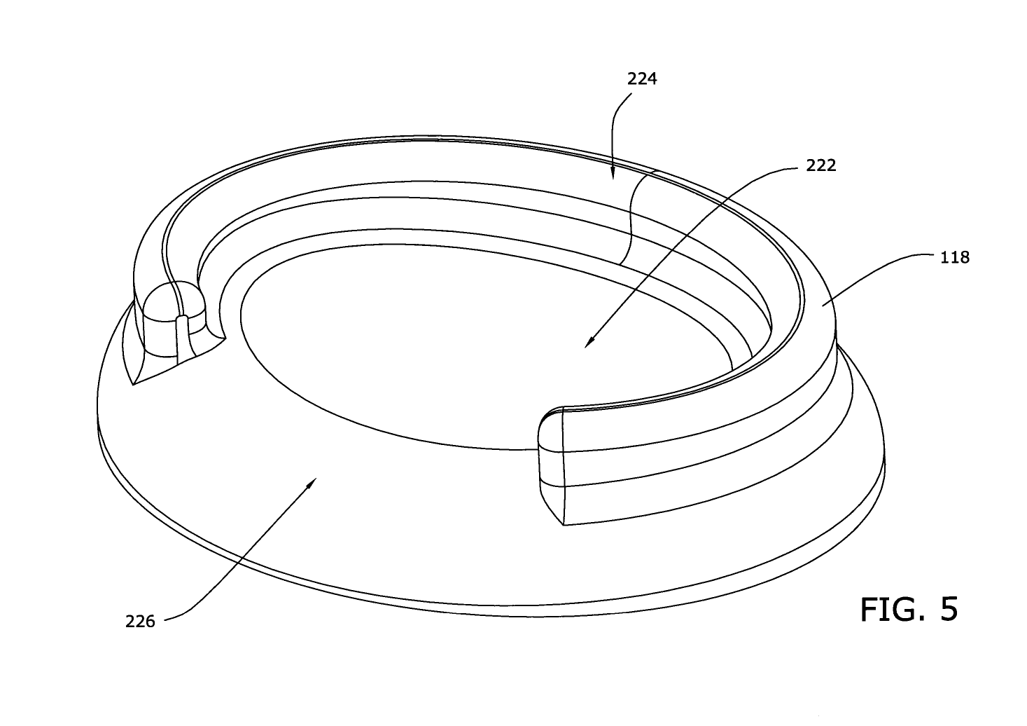

The wall structure 18 rises substantially vertically upward from the base 14 and extends around at least a portion of the complex surface contour 22 of the top surface 16 to form and define a “nesting cradle” 24 within which the animal is likely to feel even more comfortable and secure. As shown in FIGS. 1-4, the wall 18 preferably extends completely around the complex surface contour 22. As shown in FIG. 5, however, the wall 118 may alternatively extend approximately between two-thirds and three-quarters around the complex surface contour 222, thereby providing an opening 226 to facilitate the animal entering and exiting the nesting cradle 224.

It is important to note that the wall structure 18 of the one-piece bed 10 is constructed of the same visco-elastic foam material as the top surface 16. This is important because, as is commonly known, animals may frequently rest their head or legs upon a raised structure surrounding their beds. Use of the conforming foam material in the wall structure 18 of the present invention means that the animal will be substantially more comfortable when it lays upon or drapes over the wall structure 18.

The recessed space 20a,20b is provided in the body 12, preferably in the top surface 16 (as shown by the recessed space numbered 20a) or in the wall 18 (as shown by the recessed space numbered 20b), to receive and retain any of a number of accessory, complementary, or otherwise desirable substances, devices, or other items 28. The recessed space 20a may be located deeper within the body 12 and include a flap 30 to allow for closing and perhaps permanently sealing (with, e.g., glue) the recessed space 20a once the item 28 has been emplaced therein, or the recessed space 20b may be located nearer or at a surface of the body 12 and substantially or entirely open or openable to allow for removing and replacing the items 28. Additionally, there may be any number of such recessed spaces, as desired. The item 28 that may be placed within the recessed space 20a,20b may include, for example, a removable net or mesh container of insect repelling or aromatic substances, such as, for example, cedar or eucalyptus (for repelling, e.g., fleas), or a removable or non-removable heating or cooling mechanism, soothing sound generating mechanism, motion (e.g., vibration) generating mechanism, or special therapeutic device or mechanism. The item 28 might be, for example, a mesh container of a time-release medicinal or therapeutic substance such as are used to treat an allergy, asthma, or other ailments. In another example, the item 28 might be a device for generating a sound substantially similar to an adult animal's heartbeat, thereby soothing a young animal sleeping within the nesting cradle 24. In yet another example, the item 28 might be a device for generating a sound at such a frequency or wavelength as to repel or assist in repelling insects or certain types of insects (e.g., fleas). The item 28 may obtain power, if required, from one or more batteries or from a power cord, an opening for which may be provided in the body 12.

Additionally, the bed 10 may include a removable washable cover (not shown). The cover may be constructed of any suitable or desirable natural or synthetic material or combination of such materials. It will be appreciated that manufacturing such a cover is likely made easier and more economical by allowing the wall 18 to extend completely around the complex surface contour 22, thereby eliminating the additional seams which, referring to FIG. 5, would otherwise be needed about the opening 226 formed by the ends of the wall 118.

It is contemplated that the bed 10 may be adapted for use by house pets (e.g., dogs and cats). To that end, the bed 10 is shown having a substantially rounded or oval shape, and would likely have approximate dimensions as follows—length of base along major axis: between 15 inches and 60 inches; length of base along minor axis: between 12 inches and 48 inches or 80% of major axis; height from bottom surface of base to top of wall structure: between 4 inches and 14 inches. The bed 10 is not, however, limited to these or any particular shapes or dimensions.

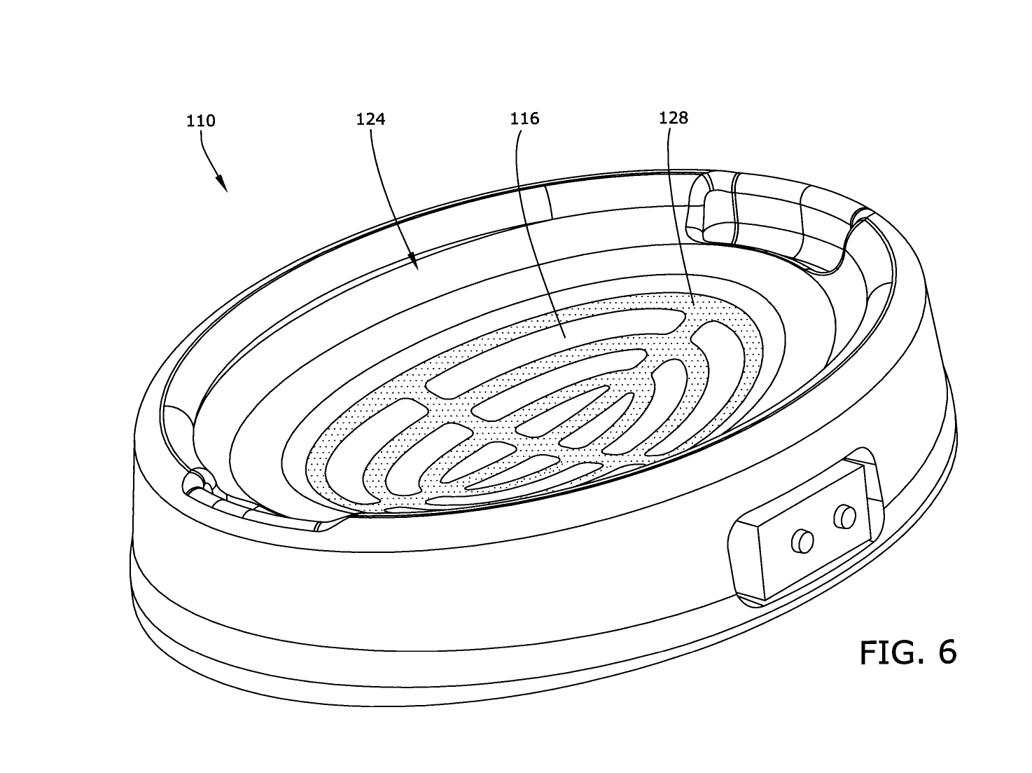

Referring particularly to FIG. 6, the bed 110 is shown with a gel insert component 128 associated with (i.e., removably or fixedly incorporated or integrated into) the top surface 116 and the nesting cradle 124. The gel insert 128 may be constructed from any suitable conventional gel or gel-like material that provides enhanced temperature regulation by conducting or transferring heat away from the top surface 116 and an animal laying thereon. The gel insert 128 is preferably constructed an integrated into the bed 110 such that the gel material of the gel insert 128 and the foam material of the top surface 116 alternate. Thus, it will be appreciated that including the gel insert 128 in the bed 110 combines the beneficial features of the visco-elastic memory foam with the increased cooling benefits of the gel material on the same surface plane. By way of construction or manufacture, it is contemplated that the gel insert 128 may be pre-molded or molded first and then laid into or positioned within a mold for forming the remainder of the bed 110, and then the foam material poured into the mold and over the gel insert 128 to form the complete bed 110.

As an alternative or supplementary cooling enhancement, thermally conductive ceramic fibers may be incorporated into the bed 10, particularly at and near the top surface 16. These fibers are similarly able to absorb heat and direct it away from the top surface 16 and the animal laying thereon.

From the preceding description, it will be appreciated that the pet bed of the present invention provides a number of advantages over the prior art, including, for example, decreased production costs, increased durability and longevity, therapeutic benefits, and improved comfort and support. More specifically, solid, one-piece molded construction decreases production costs and increases product durability and longevity over prior art multi-piece pet beds. The present invention maximizes comfort through use of both the memory foam material and the complex surface contouring of the top surface which work to reduce pressure per unit area, avoid pressure points, and provide even weight distribution. Such even weight distribution provides the additional benefit of avoiding loss of circulation and resulting numbness and/or provides or facilitates therapy or care for post-surgery pets. Additionally, the gel insert component is advantageously able to conduct heat away from the top surface and the animal laying thereon.

Although the invention has been described with reference to the preferred embodiments illustrated in the drawings, it is noted that equivalents may be employed and substitutions made herein without departing from the scope of the invention as recited in the claims. Thus, for example, the body may alternatively be constructed from any suitably responsive or conformable material, rather than the particular foam material indicated.

Having thus described the preferred embodiment of the invention, what is claimed as new and desired to be protected by Letters Patent includes the following:

1. An animal bed comprising:
a one-piece body constructed from a foam material and including
a base having a top surface,
a wall rising from the base and extending around at least a portion of the top surface, and
a recessed space provided in the wall of the body.

2. The animal bed as set forth in claim 1, wherein the foam material is a visco-elastic foam.

3. The animal bed as set forth in claim 1, wherein the foam material is heat-sensitive polyurethane visco-elastic memory foam.

4. The animal bed as set forth in claim 1, wherein the wall structure extends entirely around the top surface.

5. The animal bed as set forth in claim 1, wherein the wall structure extends no more than approximately three-quarters around the top surface.

6. The animal bed as set forth in claim 1, further including a second recessed space provided in the top surface of the base.

7. The animal bed as set forth in claim 1, wherein the base further includes a bottom surface, and the animal bed further includes a second recessed space provided in the bottom surface of the base.

8. The animal bed as set forth in claim 1, wherein the recessed space contains a substance selected from the group consisting of: insect-repelling substances, aromatic substances, medicinal substances, and therapeutic substances.

9. The animal bed as set forth in claim 1, wherein the recessed space contains a mechanism selected from the group consisting of: heating mechanisms, cooling mechanisms, sound-generating mechanisms, and motion-generating mechanisms.

10. A pet bed comprising:
a one-piece body constructed from a heat-sensitive visco-elastic foam material and including
a base having a top surface and a bottom surface, with the top surface having a surface contour,
a wall rising from the base and extending no more than approximately three-quarters around the surface contour, and
a recessed space provided in the wall of the body.

11. The pet bed as set forth in claim 10, further including a second recessed space provided in the top surface of the base.

12. The pet bed as set forth in claim 10, further including a second recessed space provided in the bottom surface of the base.

13. The pet bed as set forth in claim 10, wherein the recessed space contains a substance selected from the group consisting of: insect-repelling substances, aromatic substances, medicinal substances, and therapeutic substances.

14. The pet bed as set forth in claim 10, wherein the recessed space contains a mechanism selected from the group consisting of: heating mechanisms, cooling mechanisms, sound-generating mechanisms, and motion-generating mechanisms.

15. A pet bed comprising:
a one-piece body molded from a foam material having a thermal response characteristic for conforming itself to a pet's body, and including
a base having a top surface having a complex surface contour,
a wall rising from the base and extending at least approximately one-half around the complex surface contour, and
a recessed space provided in the wall of the body.

16. The pet bed as set forth in claim 15, further including a second recessed space provided in the top surface of the base.

17. The pet bed as set forth in claim 15, wherein the base further includes a bottom surface, and the pet bed further includes a second recessed space provided in the bottom surface of the base.

18. The pet bed as set forth in claim 15, wherein the recessed space contains a substance selected from the group consisting of: insect-repelling substances, aromatic substances, medicinal substances, and therapeutic substances.

19. The pet bed as set forth in claim 15, wherein the recessed space contains a mechanism selected from the group consisting of: heating mechanisms, cooling mechanisms, sound-generating mechanisms, and motion-generating mechanisms.
